(19) United States
(12) Patent Application Publication
(10) Pub. No.: US 2020/0265090 A1
(43) Pub. Date: Aug. 20, 2020

(54) EFFICIENT GRAPH QUERY EXECUTION ENGINE SUPPORTING GRAPHS WITH MULTIPLE VERTEX AND EDGE TYPES

(71) Applicant: Oracle International Corporation, Redwood Shores, CA (US)

(72) Inventors: Damien Hilloulin, Zurich, (CH); Davide Bartolini, Obersiggenthal (CH); Oskar Van Rest, Mountain View, CA (US); Vlad Haprian,, Zurich (CH); Sungpack Hong, Palo Alto, CA (US); Hassan Chafi,, San Mateo, CA (US)

(21) Appl. No.: 16/280,591

(22) Filed: Feb. 20, 2019

(51) Int. Cl. G06F 16/901; G06F 16/903

(52) U.S. Cl. CPC G06F 16/9024; G06F 16/903; G06F 16/902

(57) ABSTRACT

Herein are computerized techniques for processing a heterogeneous graph according to scan-avoidant query planning. In an embodiment, a computer respectively stores a first and second kind of vertices of a property graph into a first and second vertex tables. The computer generates, without scanning the second vertex table: a) an initial partial result of a query of the property graph based on the first vertex table, and b) a subsequent partial result of the query based on the initial partial result and the second kind of vertices. Herein are graph encodings that are dense, without requiring extra computation, and that exploit graph heterogeneity to achieve an aggregation granularity that reduces data working set scope, optimizes for caching, and encourages compression. Herein are query execution mechanisms and techniques that intelligently avoid accessing circumstantially extraneous data and/or structures and that can horizontally scale.

### FIELD OF THE INVENTION

The present invention relates to graph analytics. Herein are efficient techniques for processing a heterogeneous graph, including dense encoding with metadata, scan-avoidant query planning, and parallel data flow.

### BACKGROUND

Running pattern-matching queries on property graphs is a crucial step in important analytics applications such as anti-money-laundering monitoring and fraud detection. For example, a query may look for cycles of financial transactions that connect customers and bank accounts and that eventually return to the originating customer. That pattern may indicate money laundering.

In order to simplify expression of such queries, industry has been developing high-level languages such as Neo4j Cypher or Oracle PGQL. These languages broadly resemble SQL with the added capability to express graph patterns that specify traversal criteria such as an alternating sequence of vertices and edges. The queries expressed in these high-level languages are interpreted by a query execution engine that generates a query plan in the form of basic operations on the underlying graph and orchestrates the execution of the query plan to return a result.

In order to meet performance requirements (low latency/high throughput) on the query execution, the industry has developed in-memory query execution engines that run on a representation of a (e.g. hundreds of gigabytes) property graph held in virtual memory that is prone to thrashing.

Typically, such in-memory systems use a homogeneous representation of the underlying property graph. In that representation, all vertices (respectively, all edges) are uniformly encoded as having an identical set of properties, which is the union of all possible vertex properties. That causes sparsity, which degrades data locality and aggravates thrashing. Furthermore, uniform encoding of vertices (or edges) necessitates globally unique identifiers, which are wide (i.e. space intensive), which further aggravates thrashing.

In order to overcome processing bottlenecks of existing graph analysis engines, what is needed are graph encodings that are dense, without requiring extra computation. Also needed are graph encodings that exploit graph heterogeneity to achieve an aggregation granularity that reduces data working set scope, optimizes for caching, and encourages compression. Also needed are query execution mechanisms and techniques that intelligently avoid accessing circumstantially extraneous data and/or structures and that can horizontally scale.

### BRIEF DESCRIPTION OF THE DRAWINGS

In the drawings:

FIG. 1 is a block diagram that depicts an example computer that encodes a heterogeneous graph and query plans to avoid some scanning;

FIG. 2 is a flow diagram that depicts an example computer process that encodes a heterogeneous graph and query plans to avoid some scanning;

FIG. 3 is a block diagram that depicts an example computer that uses any of schematic metadata, statistical metadata, and/or column shredding to minimize data access;

FIG. 4 is a flow diagram that depicts an example computer process that uses any of schematic metadata, statistical metadata, and/or column shredding to minimize data access;

FIG. 5 is a block diagram that depicts a computer that encodes edges according to end types to minimize data access during graph traversal that entails gathering and growing paths that match query criteria;

FIG. 6 is a flow diagram that depicts an example computer process that encodes edges according to end types to minimize data access during graph traversal that entails gathering and growing paths that match query criteria;

FIG. 7 is a block diagram that depicts a computer that encodes an example graph with column shredding variations and compressed sparse row (CSR) formatting of edges;

FIG. 8 is a block diagram that depicts a computer that has partial result data structures for a query;

FIG. 9 is a block diagram that depicts a computer that decomposes query execution into units of work, some of which may concurrently execute for horizontally scaled acceleration;

FIG. 10 is a flow diagram that depicts an example computer process that decomposes query execution into units of work, some of which may concurrently execute for horizontally scaled acceleration;

FIG. 11 is a block diagram that illustrates a computer system upon which an embodiment of the invention may be implemented;

FIG. 12 is a block diagram that illustrates a basic software system that may be employed for controlling the operation of a computing system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Herein are computerized techniques for processing a heterogeneous graph according to scan-avoidant query planning. In an embodiment, a computer respectively stores a first and second kind of vertices of a property graph into a first and second vertex tables. The computer generates, without scanning the second vertex table: a) an initial partial result of a query of the property graph based on the first vertex table, and b) a subsequent partial result of the query based on the initial partial result and the second kind of vertices.

Herein are novel graph encodings that are dense, without requiring extra computation, and that exploit graph heterogeneity to achieve an aggregation granularity that reduces data working set scope, optimizes for caching, and encourages compression. Herein are novel query execution mechanisms and techniques that intelligently avoid accessing circumstantially extraneous data and/or structures and that can horizontally scale.

Also herein are techniques for encoding and traversing graph edges, and for accumulating traversal paths and recording their provenance. In an embodiment, a partial result may be homogeneously or heterogeneously data partitioned for horizontally scaled acceleration. In an embodiment, a partial result may be packaged as one or more data blocks that can be independently executed. In an embodiment, each data block is a unit of work that may be deferred, such as for scheduling.

### 1.0 Example Computer

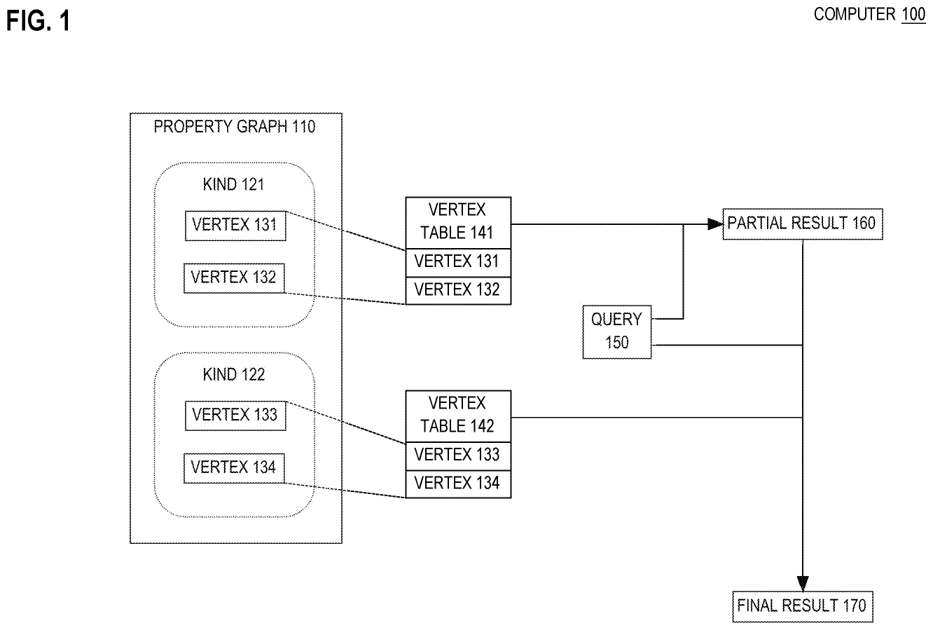

FIG. 1 is a block diagram that depicts an example computer 100, in an embodiment. Computer 100 encodes a heterogeneous graph and query plans to avoid some scanning. Computer 100 may be one or more of a rack server such as a blade, a personal computer, a mainframe, a smartphone, a virtual machine, or other computing device. FIG. 1 is streamlined to show an overview of encoding and querying of a heterogeneous graph. Mechanisms that may support FIG. 1 are presented in subsequent FIGs.

Property graph 110 is a logical construct that is shown for demonstrative purposes and may exist in a variety of encodings or storage formats in media such as disk or random access memory (RAM). Regardless of the format and residence of property graph 110, computer 100 encodes property graph 110 for analytics as a set of tables, such as vertex tables 141-142, that may also include additional tables, such as edge tables, and additional data aggregation structures, such as property vectors, which are not shown in FIG. 1 but appear in subsequent FIGs.

Property graph 110 is composed of vertices, such as 131-134, that contain or are associated with additional data (not shown) such as identifiers, properties, and interconnecting edges. Vertices are logically reified by vertex type, such as vertex kinds 121-122. For example, kind 121 may categorically represent people, with each of vertices 131-132 representing a separate person, and vertex kind 122 representing something other than people, such as equipment. In some cases, kinds 121-122 may be role based. For example, kind 121 may represent engineers, and kind 122 may represent managers. Computer 100 encodes (or receives as already encoded) each kind of vertices into a separate vertex table, such as 141-142. For example, vertex table 141 encodes kind 121, both of which contain vertices 131-132.

Computer 100 may receive or generate query 150 to analyze property graph 110. For example, the vertices of property graph 110 may be traversable along edges (not shown) to form interesting paths. For example, query 150 may specify criteria (not shown) for which computer 100 may find graph paths that match the criteria. Other techniques may encode all of the vertices of property graph 110 into a single monolithic unified vertex table. In that case, query execution may entail a full scan of the unified vertex table, even when the query criteria only apply to a particular vertex kind, which may waste time and electricity and may succumb to data non-locality, such as with thrashing a data cache.

Because vertices are arranged by kind into vertex tables 141-142, execution of query 150 may be optimized to avoid scanning (or even accessing in some cases) some vertex tables, thereby reducing how many vertices are scanned, which may accelerate query 150. For example, vertex kind 121 may represent dogs, and vertex kind 122 may represent cats, and a query for dogs need not access cat vertex table 142. For example, query 150 may scan vertex table 141 for small dogs.

Query 150 may request matching paths, each of which contains multiple vertices of various types. For example, some cats and dogs may be linked by graph edges that indicate cohabitation. Query 150 may request small dogs that live with old cats.

While other techniques need to fully scan both vertex tables 141-142 for matching cats and dogs, computer 100 may scan one vertex table and avoid scanning the other vertex table. For example, a query plan (not shown) may scan dog vertex table 141 for small dogs (shown as partial result 160), randomly access (i.e. subset, not scan) an edge table (not shown) that lists which dogs live with which cats to find cats cohabitating with small dogs, and randomly access cat vertex table 142 to narrow the found cats to old cats cohabitating with small dogs, shown as final result 170.

Although result 170 is shown as a final result, it may instead be a subsequent partial result that is not actually the final result of query 150, depending on the circumstances as discussed later herein. For example, query execution may internally generate a sequential chain of multiple partial results as discussed later herein, such as for discovering an extended graph traversal path that contains multiple vertices. Mentions herein of a final result may or may not mean a subsequent partial result and/or an actual final result, depending on the context of the discussion.

In an embodiment, vertices of a same kind are locally identified by their (e.g. array or vector) integer offset into the kind's vertex table. For example, vertices 131-132 may be locally identified by respective offsets zero and one. In an embodiment, a partial result such as 160 may contain identifiers of matching identifiers of vertices or edges. For example, vertex table 141 may contain all dogs, and partial result 160 may contain identifiers of small dogs. For example, a filtration scan of vertex table 141 may generate partial result 160.

Execution of query 150 may generate additional partial results (not shown) to represent various intermediate results. Subsequent partial results may be topologically based on previous partial results. For example, small dogs may be a previous partial result from which may be derived all cats living with small dogs as a subsequent partial result. Thus, query planning may establish cascading data flows that accumulate additional increments (i.e. hops) of (so far) matching traversals. Thus, subsequent partial results contain longer traversal paths than previous partial results. Likewise, final result 170 may either directly contain traversal paths of full length (e.g. as specified in query 150), contain only vertices (e.g. identifiers) at the end of those paths, or contain only field values projected from vertices.

Partial results are of special importance for query plan optimization as discussed later herein. For example, partial results represent units of work that may be cascaded within a data flow. Also as discussed later herein, the heterogenous nature of property graph 110 may be used to divide a partial result into batches of subtypes and/or identifier subsets, which facilitates parallel execution.

### 2.0 Example Graph Analysis Process

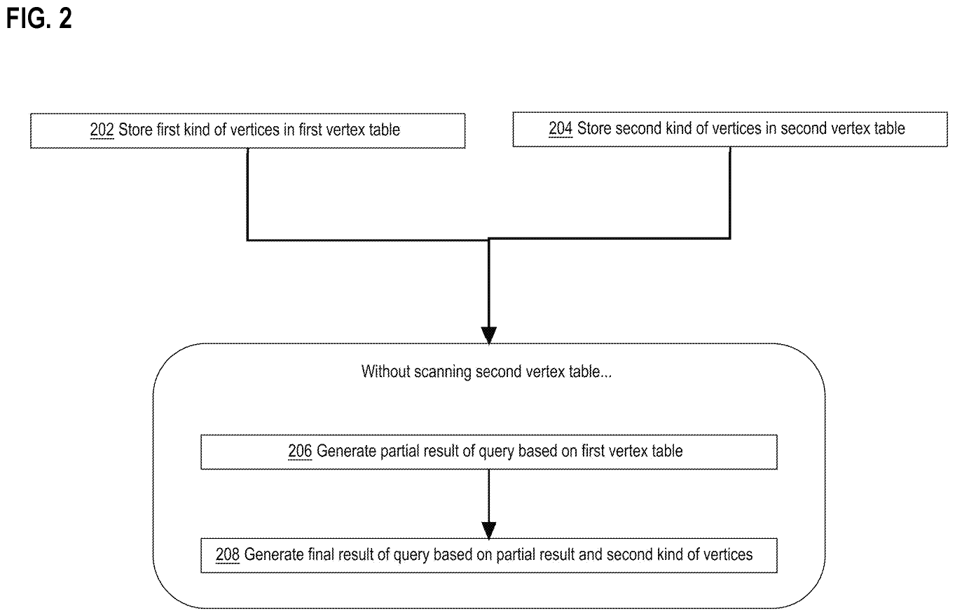

FIG. 2 is a flow diagram that depicts computer 100 as it encodes a heterogeneous graph and query plans to avoid some scanning, in an embodiment. FIG. 2 is discussed with reference to FIG. 1.

This process occurs in two phases, graph loading followed by query execution, between which much or little time may elapse. The loading phase includes steps 202 and 204 that may serially or concurrently occur.

Each of steps 202 and 204 stores a respective kind of vertices into a respective vertex table. For example, vertex kinds 121-122 are respectively loaded into vertex tables 141-142.

Graph loading may be eager, such as loading all vertex tables during system initialization, or lazy such as not loading some vertex tables until receiving query 150 that references some vertex kinds such as 121-122. Lazy loading of a particular vertex table may be deferred into the query execution phase. For example, vertex table 141 should be loaded before executing step 206. Whereas, loading of vertex table 142 may be deferred until between steps 206 and 208, because vertex table 142 is not needed until step 208. Thus, the loading and execution phases may somewhat overlap.

In an embodiment, vertex tables are loaded one or a few at a time upon system initialization, perhaps scheduled or otherwise throttled through a queue or priority queue, and query execution may stall at any step until a needed table is loaded. In a queued loading embodiment, loading of a suddenly needed table may be expedited by being moved to the head of a (e.g. priority) queue. Tables may remain loaded for use by concurrent or subsequent queries. Loaded tables may be cached according to a policy such as least recently used (LRU) and may be subsequently reloaded after eviction.

Actual query execution occurs during steps 206 and 208, which are necessarily sequential. Query 150 references two kinds of vertices 121-122. However query execution, including steps 206 and 208, may scan only one of two involved vertex tables as follows.

Step 206 generates a partial result by scanning vertex table 141 to discover vertices of one kind that match query criteria. Step 208 generates result 170 based on the partial result of step 206 and possible access (but not scanning) of other vertex table 142 depending on the query scenario. For example in a first scenario where vertex kinds 121-122 represent animals, then query 150 for animal wingspans need not access vertex table 142 that may represent cows.

In a second scenario, vertex kinds 121-122 are semantically related to each other. For example, dogs may chase cats, and a query for old cats chased by green dogs may operate as follows. Step 206 finds green dogs and records that as partial result 160, which is injected as input into step 208 that selectively discovers which cats are chased by those green dogs and which of those cats are old.

In that case, step 208 may randomly access cat vertex table 142 without actually scanning table 142. Random access is discussed later herein. In either scenario, avoidance of scanning (or even accessing) a second vertex table may be guided by vertex table metadata as discussed later herein. Also in either scenario, step 208 generates final result 170 that is directly or indirectly based on partial result 160.

### 3.0 Data Normalization and Metadata

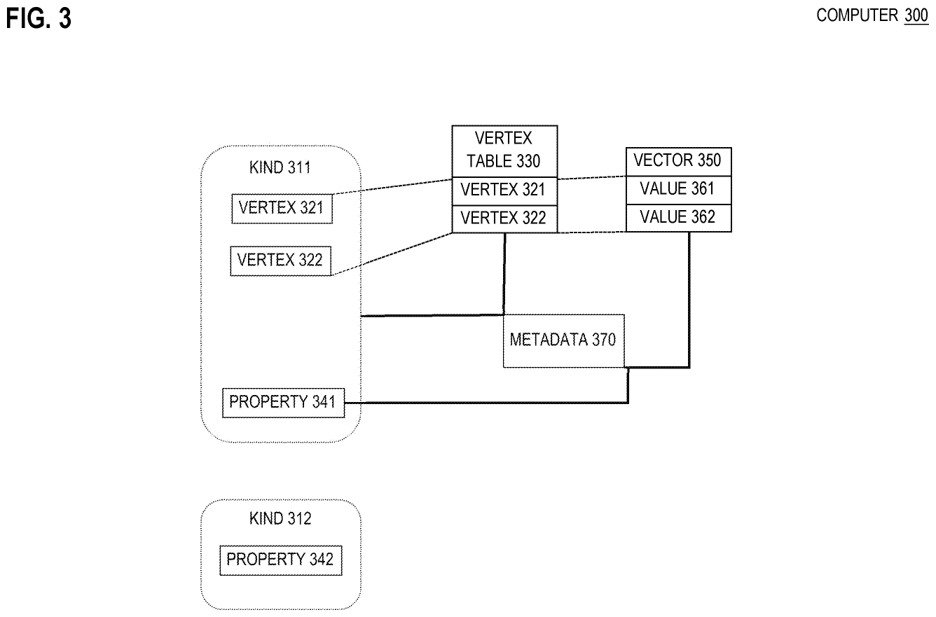

FIG. 3 is a block diagram that depicts an example computer 300, in an embodiment. Computer 300 uses any of schematic metadata, statistical metadata, and/or column shredding to minimize data access. Computer 300 may be an implementation of computer 100.

Computer 300 may store vertices of a heterogenous graph (not shown) into vertex tables by kind. For example, vertex kind 311 and vertex table 330 contains vertices 321-322. A kind of vertex may have data properties. For example, vertex kind 311 has at least property 341. Each vertex of a same kind may have a respective value of a same property. For example, vertices 321-322 have respective values 361-362 of property 341.

Other kinds of vertices may have same and/or different properties as vertex kind 311. For example, properties 341-342 may be a same or different property. For example, vertex kind 311 may represent dogs, vertex kind 312 may represent cats. For example, both of properties 341-342 may be a same fur color property. In another example, property 342 may be a count of multiple lives, which only cats have.

Vertex kind 311 may be column shredded, such that some or all properties are each stored in a separate vector, such as 350. For example, property 341 may be an age property, vector 350 may be an age vector, and values 361-362 may be ages of respective vertices 321-322. In an embodiment, each property has its own value vector.

In an embodiment, a property vector may be compressed, such as dictionary encoding and/or run length encoding (RLE). In an embodiment, a property is first dictionary encoded and then additionally run length encoded. Data parallel hardware may provide inelastic horizontal scaling for acceleration, such as with single instruction multiple data (SIMD) and/or a vector processor such as a graphical processing unit (GPU). A dictionary encoded vector may be amenable to data parallel hardware. Scan, group, sort, and join may be data parallelized for a decoded or dictionary encoded property vector. Whereas, operations upon an RLE vector are amenable to sequential optimization.

In an embodiment, some value vectors may be joined and stored as a two-dimensional table (not shown), with each table column containing values of a respective property. For example, properties that are often contemporaneously accessed may reside in a same property table to achieve spatial locality by exploiting temporal locality. However, even when properties 341-342 are a same property, they have separate vectors because separate vertex kinds 311-312 are involved. In other words, properties of separate vertex kinds are not comingled.

Property vectors maximize data locality and minimize data access as follows. When values of a property reside in a separate vector, only that vector needs accessing for filtration upon that property. For example, a vertex kind may have only relevant property vector(s) loaded into a cache. Likewise, because each vertex kind (e.g. cats and dogs) has a separate vector even for a same property (e.g. age), scanning for old cats may avoid scanning a dog age vector.

In an embodiment, some properties are not separate vectors but are instead separate columns within vertex table 330 that may be two dimensional. In the embodiment shown, no properties are contained directly within vertex table 330. In an embodiment, vertex table 330 is demonstrative and implied rather than actually constructed, such that there is no vertex table, and vertex kind 311 is represented essentially as a set of property vectors only.

Whether a two dimensional table or a one dimensional table is involved, each row is indexable by integer offset and corresponds to a distinct vertex. Thus, each vertex of a same kind may be locally identified (i.e. within that kind) by the integer offset of the vertex within the table or vector, and the offset identifier is the same for the same vertex in all property vectors and the vertex table of that kind. For example, vertex 321 may have identifier zero that is a same offset into vertex table 330, property vector 350, and any other property vectors (not shown) of kind 311. Thus a vertex table and the property tables of a same vertex kind may logically be used as so-called parallel arrays that share a same indexing range.

Computer 300 may maintain and use metadata, such as 370, to avoid data access for acceleration. Each kind of vertices may have its own metadata. For example, metadata 370 describes vertex kind 311.

Metadata 370 may specify schematic details. For example, metadata 370 indicate that vertex table 330 is associated with vertex kind 311. Metadata 370 may indicate that property 341 is associated with vector 350. Computer 300 may use schematic metadata for acceleration. For example, inspection of metadata instances for vertex kinds 311-312 may reveal that property 341 is peculiar to vertex kind 311. Thus, only vertex kind 311 and not vertex kind 312 may be relevant to a query that references only property 341. For example, query execution may scan vertex table 330, but may more or less avoid accessing the vertex table (not shown) of kind 312.

Metadata 370 may specify statistical details. For example, metadata 370 may indicate a minimum and maximum value that occurs in vector 350. For example, property vector 350 may be an age vector whose maximum value of ten years is indicated in metadata 370. Query execution may entirely avoid accessing age vector 350 when searching for ages greater than that maximum of ten years, such as a query to find adults.

Metadata 370 may count or enumerate all distinct values of vector 350. Metadata 370 may contain a histogram that counts occurrences of each distinct value of vector 350. Metadata 370 may contain counts (i.e. degree) of fan in and/or fan out of inbound or outbound edges for each vertex of a same kind.

### 4.0 Example Metadata Driven Process

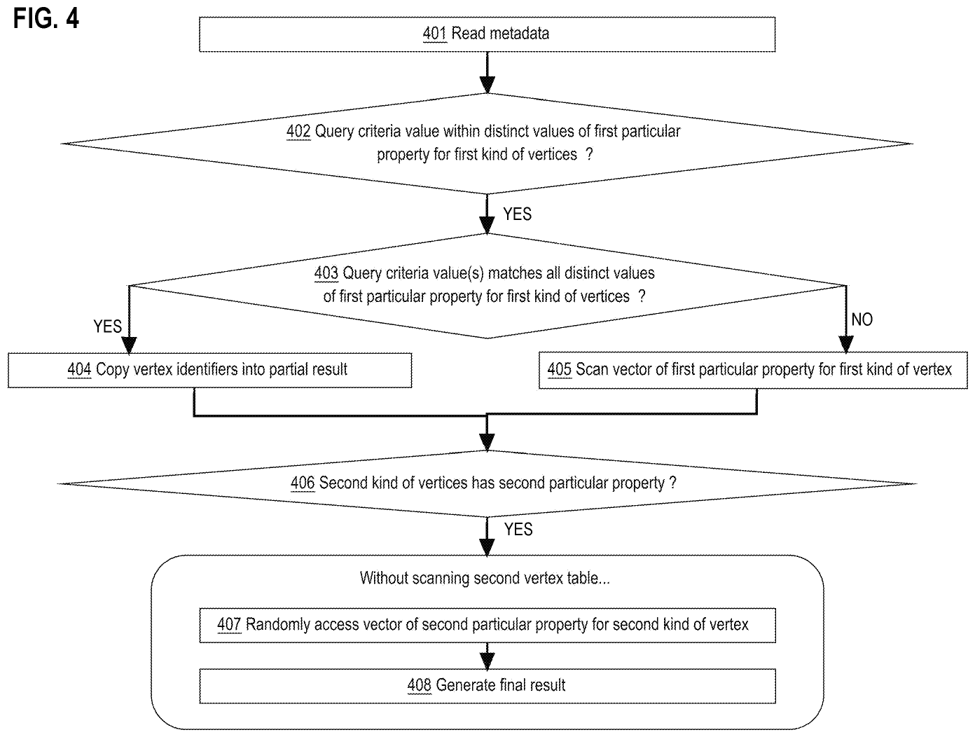

FIG. 4 is a flow diagram that depicts computer 300 as it uses any of schematic metadata, statistical metadata, and/or column shredding to minimize data access, in an embodiment. FIG. 4 is discussed with reference to FIG. 3. FIG. 4 shows a subset of control flow paths based on various dynamic decisions during query execution.

Step 401 is preparatory and reads metadata, such as 370, of various granularities such as per vertex table and/or per property vector. Various granularities may be lazily read such as just in time. For example, metadata for property vector 350 may be needed before metadata for another property vector of a same or different vertex table. For example, decision steps 402-403 and 406 occur at different times and may need same or different metadata.

Discussion of FIG. 4 is based on an example query that finds old cats chased by green dogs as also discussed above. Steps 402-405 find green dogs. Steps 406-408 find the old cats that those dogs chase.

Metadata 370 may indicate various aspects of dog vertex kind 311, including which properties do dogs have. Because green animals are specified by the query's filtration criteria, decision step 402 analyzes metadata 370 to discover that property 341 is color whose values are stored in dog color property vector 350. Metadata 370 may also indicate value statistics, such as which distinct colors occur in dog color property vector 350. For example, a graph may only have purple and green dogs, in which case metadata 370 indicates only purple and green. Decision step 402 further analyzes metadata 370 to discover whether or not the graph has green dogs. If metadata 370 confirms that green dogs occur, then execution proceeds to step 403. Otherwise if metadata 370 indicates various colors but not green, then query execution ceases and indicates that no matches were found.

After step 402 confirms that green dogs occur, step 403 again analyzes metadata 370 to detect whether or not all of the graph's dogs are green. For example, metadata 370 may indicate that green is the only distinct color that occurs in dog color property vector 350. If all dogs are green, execution proceeds to step 404, which is discussed later herein. If only some dogs are green, execution instead proceeds to step 405.

Step 405 detects which dogs are green, which entails scanning dog color property vector 350 to discover which property value entries indicate green and accumulating the offsets of the green entries into a partial result. Because data structures 330 and 350 share a same offset range and are so-called parallel structures, the offsets of the green entries may also be subsequently used as offsets into dog vertex table 330 or into other dog property vectors (not shown).

In an embodiment, inspecting the values within dog color property vector 350 entails a full scan. In another embodiment, metadata 370 has a histogram that indicates counts of dogs for each distinct dog color, which may be used for acceleration by performing a partial scan instead of a full scan. For example, if the histogram indicates two green dogs, then scanning may cease after reaching a second green value within dog color property vector 350.

As discussed above, step 404 occurs instead of step 405 when all dogs are green, in which case even a partial scan is unnecessary. Step 404 may populate the partial result instead with the full range of offsets, which may be discovered according to a (e.g. already cached or otherwise known) count of rows in dog vertex table 330 or in any (e.g. not color) dog property vector.

If the query were generalized to specify chasing by any green animal (e.g. cat or dog) instead of only by green dogs, then steps 402-405 may be repeated for each vertex kind that has a color property. For example, cat property 342 may or may not be color, which other metadata (not shown) may indicate. As discussed later herein, each vertex type that may be green may have its own partial result that sooner or later is combined to directly or indirectly generate the final result.

Both of alternative steps 404-405 are followed by decision step 406 that detects which vertex types may be chased by dogs, which subset of those vertex types have an age property, and which vertex types in that subset may be old, such as old cats. Analysis and decisions by step 406 may be similar to those of steps 402-403. However, the activities that occur after step 406 may be very different from what occurs after step 403.

Specifically, there need be no scan of cats. Instead, step 407 randomly accesses the cat age property. Random access is based on already knowing which dogs are green and which cats are chased by those dogs, which entails edge analysis, which is discussed later herein. Thus, a partial result that identifies (i.e. offsets into the cat vertex table) which cats are chased by green dogs is injected as input into step 407.

Random access may be part of age filtration of cats, which may accumulate identifiers of matching old cats. Random access is discussed later herein. Finally, step 408 generates a final result, such as projection of various properties of matching green dogs and old cats, which may also entail random access into property vectors. For example, the query may project the color and weight of the matching old cats. The final result may be internally consumed such as by procedural logic and/or injected into subsequent queries, externally reported such as to a client or surveillance, and/or saved to a file for later use.

### 5.0 Graph Edges

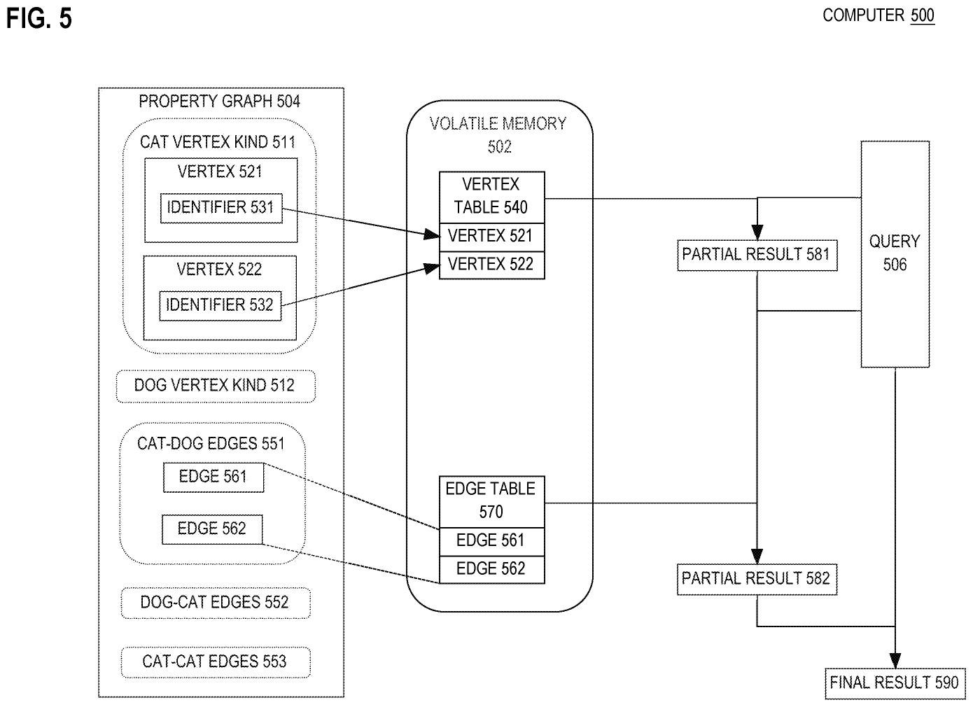

FIG. 5 is a block diagram that depicts an example computer 500, in an embodiment. Computer 500 encodes edges according to end types to minimize data access during graph traversal that entails gathering and growing paths that match query criteria. Computer 500 may be an implementation of computer 100.

Path query 506 may specify an ordered sequence of criteria for vertices and/or edges of graph traversals. For example, query 506 may request which dogs chase which cats, and/or which dogs live with which cats, as a same or separate queries.

In an embodiment, edges are directed. Edges originate at one vertex and terminate at a same or different vertex of a same or different kind. For example, a cat may live with a dog or another cat. An edge may be reflexive (i.e. self-referential), such that the edge originates and terminates at a same vertex. For example, a cat may help itself instead of helping another cat or dog.

Other techniques may categorize edges by type or not at all. For example, each edge may bear a single label that indicates the type (i.e. kind) of the edge, and some edges may have a same type. However, techniques herein innovate by categorizing edges by the kinds of their connected vertices. For example, brave cats may chase dogs, timid cats may flee dogs, and friendly dogs may like cats. Thus, a property graph may have edges with labels such as chase, flee, and like.

However unlike other techniques, edges need not be aggregated according to those labels. Indeed, those labels may be implemented as mere values of a (e.g. same) property, such as in property vector(s). Both vertex properties and edge properties may have value vectors. Instead, edge aggregation occurs according to connected vertex types.

For example, whether a cat chases or flees a dog may be irrelevant, because both labels occur for directed edges that originate at a cat and terminate at a dog. Each directed pairing of vertex types may have its own edge table, such as edge tables 551-553. Thus, a cat that chases one dog and flees another dog may have two edges, both of which are stored in same edge table 551 that is reserved for directed edges from cats to dogs.

Whereas when a dog chases a cat, there is an edge that originates from a dog and terminates at a cat, which is a directed pairing from dog to cat, which is not the same as a pairing in the opposite direction from cat to dog. Thus, edges with a different direction may belong in a different edge table, such as 552. Indeed, if a cat chases a dog that chases another cat, then there is one edge that terminates at the dog and another edge that originates at the dog, which are opposite directions. Thus, those two edges belong in separate edge tables 551-552 even though they have a same label. If a cat chases another cat or itself, then edge table 553 is needed.

Each edge table may have associated metadata, such as schematic and statistical metadata as discussed above for metadata associated with a vertex table. Edge table metadata may accelerate graph traversal by avoiding accessing and/or scanning circumstantially irrelevant edge tables.

Thus, property graph 504 may be encoded as vertex tables, such as 540, and edge tables such as 570. Tables 540 and 570 and their associated property vectors (not shown) may be stored within volatile memory 502, such as a static RAM (SRAM) for speed or a dynamic RAM (DRAM) for fabrication density and power savings. In an embodiment, only a subset of vertex and/or edge tables occupy volatile memory 502. For example, property graph 504 may reside in durable storage such as disk in similar (e.g. shredded) or different (e.g. not shredded) data structures, and volatile memory 502 may operate as a cache of vertices and/or edges and/or their property vectors. As discussed earlier and later herein, accessing some tables or vectors may be entirely avoided, which means that some tables or vectors need not be cached for query 506. Thus, maximum speed may be preserved even when property graph 504 is too big to fit all of its tables and vectors into volatile memory 502. Access avoidance may also minimize thrashing of a cache or virtual memory.

Vertices and edges may have identifiers such as 531-532. In an embodiment, a vertex or edge is locally identified within a table such as 540 or 570 by an integer row offset into the table. Local offsets are unique within a table, but may not be unique across multiple tables. For example, vertex 521 and edge 561 may have a same offset as a local identifier.

Other techniques may achieve a globally unique identifier that combines a local identifier with a table identifier. For example partial result 581 may contain a mix of cats from vertex table 540 and dogs from another vertex table. In that case, other techniques may store globally unique identifiers of cats and dogs within partial result 581.

Whereas, techniques herein innovate by forgoing the need for global identifiers. As discussed later herein, partial result 581 need contain only local identifiers that are internally segregated by vertex table. For example, partial result 581 may have an array of cat local identifiers and a separate array of dog local identifiers.

Edges may also have local identifiers, such as for edge table 570 and stored in partial result 582. For example, execution of query 506 for old cats that like dogs may accumulate and propagate identifiers as follows. Partial result 581 may have identifiers of old cats.

Some old cats do not like dogs. Other old cats like multiple dogs. Thus some, but not all, old cat identifiers are propagated from partial result 581 to partial result 582. Likewise, some old cat identifiers may occur repeatedly within partial result 582. Partial result 582 may also contain local identifiers of involved edges, which have a likes label.

As discussed above, partial results are (e.g. heterogeneous) accumulations of intermediate traversals. Optimized formats for storing data within partial results are discussed later herein.

### 6.0 Example Edge Traversal Process

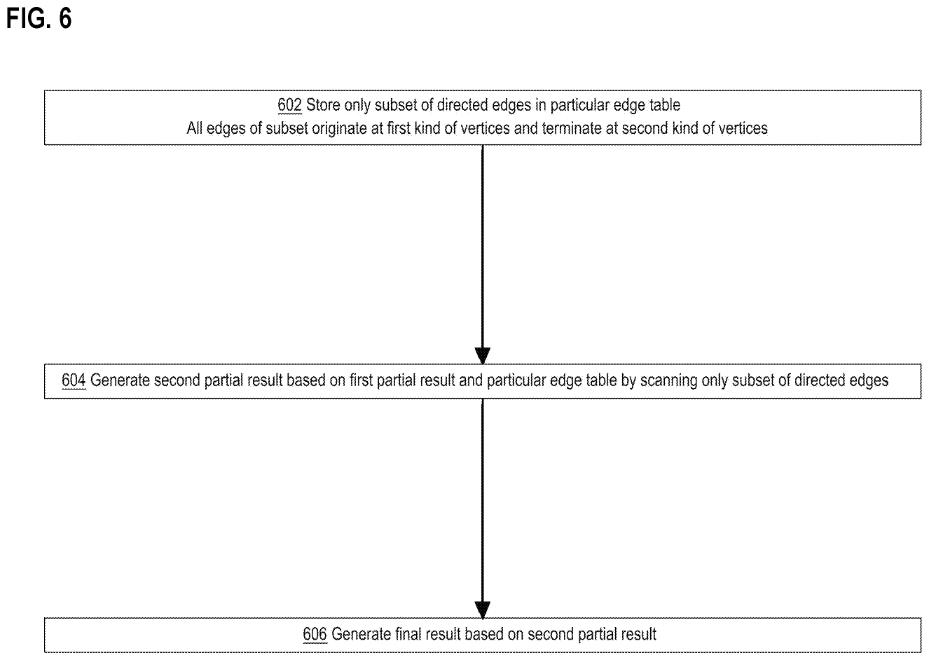

FIG. 6 is a flow diagram that depicts computer 500 as it encodes edges according to end types to minimize data access during graph traversal that entails gathering and growing paths that match query criteria, in an embodiment. FIG. 6 is discussed with reference to FIG. 5.

Step 602 is preparatory. Actual query execution occurs during steps 604 and 606. Each directed graph edge connects an originating vertex with a terminating vertex. Step 602 segregates directed edges into subsets according to those directed pairings of originating vertex type and terminating vertex type. Each subset, such as 551-553, is stored into its own separate edge table, such as 570. Edge table loading may be lazy or eager as discussed above for vertex tables.

In this example, query 506 finds old cats that like dogs, which initially entails scanning a cat age property vector (not shown) for old cats, whose identifiers are stored into partial result 581, which is injected as input into step 604. Step 604 scans cat-dog edges to discover which dogs are liked by those cats as follows. Tables and property vectors of other edge subsets, such as cat-cat, need not be accessed by execution of this query. Thus, heterogeneity may accelerate edge analysis in ways similar to how heterogeneity accelerates vertex access as discussed above.

Edges may have a pair of properties that identify originating and terminating vertex identifiers. Those properties may occur as columns within an edge table or be shredded into edge property vectors. Thus, step 604 may scan either cat-dog edge table 570 or a cat-dog terminating vertex property vector (not shown). Edge property formatting is discussed later herein.

A cat may originate multiple edges to a same dog. The edge scan should filter for which edges are likes, if any, which may entail accessing an edge property, either as a column in cat-dog edge table 570 or shredded into a cat-dog property vector. Edge filtration is discussed later herein. Step 604 harvests matching cat-dog edges and stores their terminating dog vertex identifiers into partial result 582 that is injected as input into step 606.

Finally, step 606 performs concluding activities such as projection, sorting, and/or grouping that is directly or indirectly based on partial results 581-582. Because partial results may contain tuples of identifiers of vertices and edges along traversal paths, final projection may access properties anywhere along the path.

Concluding activities are discussed later herein. Indeed, much or all of the processing in FIG. 6 is discussed in more detail later herein for subsequent figures.

FIG. 4 depicts filtration of originating and/or terminating vertices. FIG. 6 depicts filtration of edges and/or neighbor vertices. Both of FIGS. 4 and 6 show initial and final steps that should occur at most once per system initialization and/or query. The intermediate steps of FIGS. 4 and 6 may be combined and repeated to achieve cascaded hops along edges and vertices that facilitate filtered graph traversal such as for path queries. Thus, techniques herein achieve a general graph query engine.

### 7.0 Data Encoding

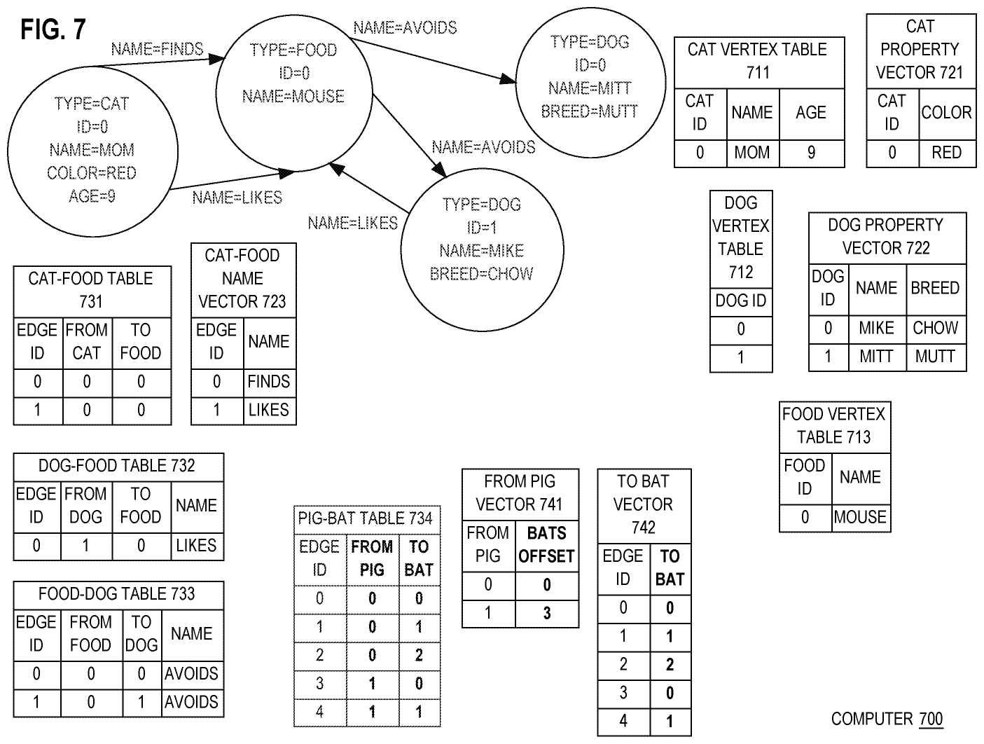

FIG. 7 is a block diagram that depicts an example computer 700, in an embodiment. Computer 700 encodes an example graph with column shredding variations and compressed sparse row (CSR) formatting of edges. Computer 700 may be an implementation of computer 100.

The vertices of the shown directed property graph are encoded into vertex tables 711-713. Column shredding may occur for none, some, or all columns of a vertex type. For example, food vertices are not shredded, and all properties occur as columns, such as name, that are stored directly within food vertex table 713.

Dog vertices are shredded in a way that puts all properties into dog property vector 722, leaving no properties in dog vertex table 712. In an embodiment not shown, dog property vector 722 is further shredded into single property vectors.

Cat vertices have some property columns shredded into cat property vector 721 and other property columns stored directly within cat vertex table 711. The leftmost identifier column of data structures 711-713, 721-723, 731-734, and 741-742 are demonstrative, implied, and not actually stored. For example, dog vertex table 712 may itself be demonstrative, implied, and not actually stored.

Property columns of directed edges may also have varied shredding, such as into cat-mouse name vector 723, with some property columns stored directly within edge tables such as 732-733. Even when the leftmost edge identifier column is implied and not actually stored, an edge table still usually has at least two columns for local identifiers of originating and terminating vertices, although one or both of those columns may also be shredded into property vectors, such as to bat vector 742 that stores identifiers of terminating vertices as a shredded property as discussed below.

Although not shown in the graph, there may be vertices that represent pigs and bats. In midair, pigs may collide into bats, and each collision is represented by a directed edge of the graph, which may be encoded as pig-bat table 734. As shown in bold, pig-bat table 734 stores ten local identifiers of pigs and bats, which is ten integers.

With compressed sparse row (CSR) encoding, the same collision edges may be encoded in a way that only needs seven integers (also shown bold) instead of ten, which clearly saves space and may also save time in various ways such as reduced thrashing, initializing, and transferring such as between address spaces, networked computers, or storage tiers. CSR needs a pair of one dimensional arrays of different sizes. Thus, compressed vectors 741-742 together are an implementation alternative to pig-bat table 734.

To bat table 742 lists the terminating bat vertex identifiers of the collision edges. The to bat column of to bat vector 742 has the same bat identifier values as the to bat column in pig-bat table 734, so long as pig-bat table 734 is sorted by pig identifier, such that all edges that originate from a same pig are contiguous within data structures 734 and 742. The to bat columns of data structures 734 and 742 have some duplicate bat identifiers because some bats have multiple collisions.

From pig vector 741 lists the originating pig vertex identifiers. The bats offset column stores the first offset, within to bat vector 742, of a collision edge that originates from the given pig. For example, pig 0's first edge identifier is 0, and pig l's first edge is 3. Because edges originating from a same vertex are contiguous within to bat vector 742, all of the edges from 0 until just before 3 (i.e. edges 0-2) originate from pig 0. Thus, CSR usefully encodes the same graph topology as an uncompressed edge table, but needs less space. With CSR, edge properties may be shredded or embedded as columns (not shown) within to bat vector 742.

Adjacent values within from pig vector 741 may be used to detect fan out degree of a pig vertex in constant time. For example, pig 0 originates 3 minus 0=three edges. In an embodiment, traversal and/or detection of degrees of bat fan in are likewise accelerated with additional CSR data structures (not shown) that record the same edges as vectors 741 and/or 742, but as if the direction of the edges were theoretically reversed. In an embodiment, undirected edges are encoded as a pair of synthesized directed edges of opposing directions.

### 8.0 Partial Results

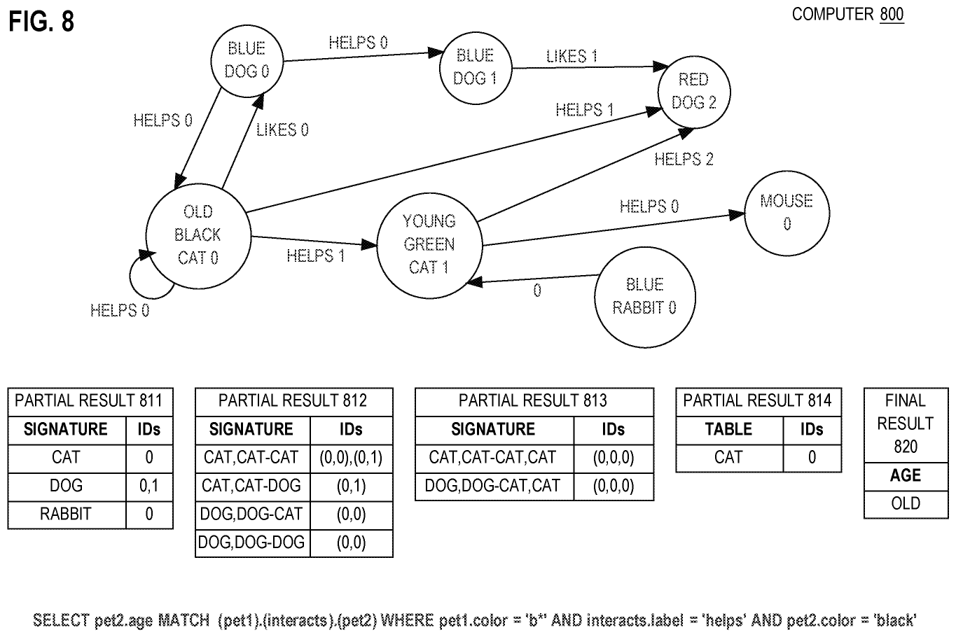

FIG. 8 is a block diagram that depicts an example computer 800, in an embodiment. Computer 800 has partial result data structures for a query. Computer 800 may be an implementation of computer 100.

FIG. 8 shows example query “SELECT pet2.age MATCH (pet1).(interacts).(pet2) WHERE pet1.color=‘b*’ AND interacts.label=‘helps’ AND pet2.color=‘black’” of the shown directed property graph. The query is expressed according to a grammar as follows. Placeholder variables are individually introduced within parenthesis, which are pet1, interacts, and pet2. The asterisk is a wildcard that matches any text. The query finds vertices whose color start with the letter b. The query returns the age of vertices that are helped by the matching initial vertices. Query execution accumulates partial results as follows.

The query may be decomposed into clauses that begin with fully capitalized keywords, SELECT, MATCH, and WHERE. The MATCH clause specifies a graph traversal as a sequence from a vertex, through an edge, to another vertex, each of which has a placeholder variable pet1, interacts, or pet2. Query execution entails exploring that sequence to discover matching graph paths by matching each variable in sequence.

In the example graph, each vertex may or may not have properties such as color and/or age. For example, mouse 0 has no properties. Each vertex has a type such as cat, dog, rabbit, or mouse. Each vertex also has a local identifier that is only unique within the vertex's type. For example, dog 0 and cat 0 have a same local identifier 0 but are different vertices.

The first variable, pet1, if otherwise unconstrained, could initially match all vertices of the graph. However, the WHERE clause specifies filtration criteria that indicates that each matching pet1 should have a color property with a text value that starts with b. Either the mouse vertex type does not have a color property, or at least there are no mice whose color begins with b, and thus first partial result 811 contains only identifiers of matching vertices that are not mice. Generally all partial results, such as 811-813, may have a same internal format. In other words, partial results may be uniformly formatted to facilitate generic processing of a partial result without regard for context within the greater query execution.

A partial result may contain a table with two columns. The signature column indicates provenance. For example, partial result 811 is heterogeneous, and its signature column indicates which vertex tables (not shown) contributed matching vertices (i.e. vertices with colors beginning with b). The identifier column has the local identifiers of the matching vertices (or edges), segregated by vertex (or edge) type. For example, two dogs match the query so far, and so partial result 811 has two dog identifiers. Thus, each entry in the identifier column may itself be an array of matching identifiers.

Next, query execution attempts the next variable in the traversal sequence, which is interacts, which is an edge variable. A variable may match either edges or vertices, but not both. Generally a query's MATCH clause may be an alternating sequence of vertex variable, edge variable, vertex variable, edge variable, and so forth. In an embodiment, the MATCH clause may contain a regular expression, such as for pattern repetition, and/or some edges or vertices in the query path may be implied. For example, edge roads may interconnect vertex cities, and a query may seek routes between Miami and Sacramento without specifying how many intermediate cities must matching paths contain. For example, a query may find multiple matching paths of different lengths.

In the example graph, each edge has a local identifier that is only unique within the edge table (not shown) that stores the edge. For example, edges from cats to dogs may occupy one edge table, and edges in the opposite direction from dogs to cats may occupy another edge table. Thus, both edges between dog 0 and cat 0 may have same local edge identifier 0 as shown.

Each edge may or may not have properties such as weight (not shown) or label. For example, edge 0 between dogs 0-1 has a label whose value is helps. Likewise, edge 0 between rabbit 0 and cat 1 does not have a label property.

Partial result 812 demonstrates development of ongoing traversals as follows. The edge variable interacts should only match edges that originate from the vertices identified in previous partial result 811. The WHERE clause of the query also specifies that the interacts variable should only match edges labeled helps. Either edges originating from rabbits do not have a label property, or at least there are no edges labeled helps from rabbits. Thus, the rabbit data in partial result 811 is not propagated into partial result 812, which does not identify any rabbit edge table.

The only matching helps edges are those that occur in cat-cat, cat-dog, dog-cat, or dog-dog edge tables (not shown). Thus, the signature column of partial results 812 identifies those edge tables. Each entry in the signature column may identify an alternating sequence of vertex and edge tables that were traversed as matching so far.

Thus, each entry of the signature column may itself be an array of parenthesized pairs. For example, the first row of the signature column of partial result 812 indicates that two matching edges originate and terminate at cats. Each parenthesized pair within partial result 812 indicates a different edge and thus a different path.

Partial results 812-813 have identifier columns whose values may be arrays of parenthesized tuples. Each tuple identifies an ongoing path as an alternating sequence of vertex and edge identifiers. For example, each tuple of partial result 812 contains a vertex identifier followed by an edge identifier. For example, the cat-dog row of partial result 812 identifies cat vertex 0 and cat-dog edge 1 that is labeled helps and terminates at dog 2.

Next, query execution attempts the last variable in the traversal sequence, which is pet2, which is a vertex variable. Variable pet2 should only match vertices that are reached by edges identified in partial result 812. The WHERE clause also specifies that pet2 should have a color property with a value of black.

No dogs are black. Thus, data from the cat-dog and dog-dog rows, which specify edges terminating at dogs, within partial result 812 are not propagated into partial result 813. Thus, all of the signature values in partial result 813 are arrays that end with cat, even though the query did not expressly ask only for cats.

Only cat 0 is black. Thus, the identifier column of partial result 813 only contains arrays that end with 0, which represent paths terminating at cat 0. Even though both entries within the identifier column of partial result 813 appear identical as (0,0,0), both entries actually identify different paths. That is because identifiers are local and not globally unique. Thus, the top (0,0,0) represents a path that originates at cat 0, and the bottom (0,0,0) represents a path that originates at dog 0.

Each of partial results 811-813 has a different amount of rows. For example due to fan out, a vertex may originate multiple edges, which may cause partial result 812 to have more rows than partial result 811. Likewise, partial result 813 has fewer rows than partial result 812 due to filtration.

In an embodiment, final result 820 is derived directly from partial result 813. In another embodiment, that derivation also entails partial result 814, which is extraordinary as follows. Unlike other partial results, 814 is an optimization with a different internal format. While generating partial result 814, computer 800 recognizes that the query projects (i.e. SELECT clause) only pet2, which circumstantially could not be a dog. Furthermore, the projection disregards the matching paths and only regards the terminating cat(s). Thus full signatures are unnecessary. Furthermore, de-duplication of redundant paths is possible. For example, both paths of partial result 813 terminate at cat 0.

In an embodiment, partial result 814 is not generated, and the heuristics that populated partial result 814 may instead be used to directly populate final result 820. In either case, final result 820 may apply the projection of the SELECT clause, which entails extracting the age property value of matching terminating vertices. In this example, circumstantially only one terminating vertex matches, cat 0, whose age is old. The same query applied to a different graph may match multiple terminating vertices and thus final result 820 may return multiple ages.

### 9.0 Parallelism

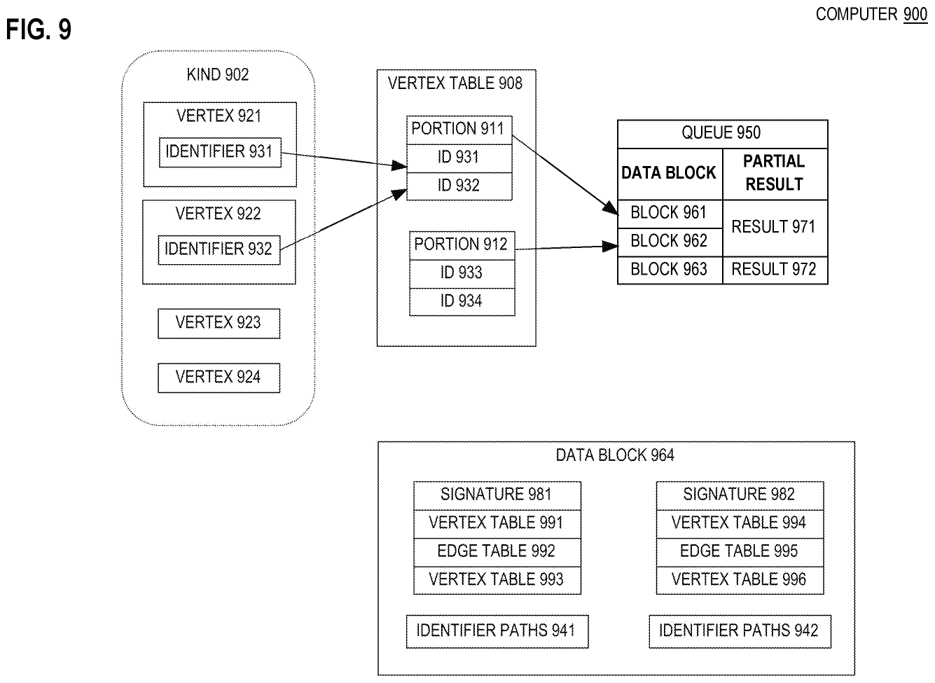

FIG. 9 is a block diagram that depicts an example computer 900, in an embodiment. Computer 900 decomposes query execution into units of work, some of which may concurrently execute for horizontally scaled acceleration. Computer 900 may be an implementation of computer 100.

Execution of a query (not shown) entails various conceptual dimensions, such as functional decomposition and data partitioning, that each may facilitate parallelism in a more or less distinct way. However, because of the uniform formatting of partial results as discussed above, generalized parallelism may be possible despite distinct ways of subdividing work. FIG. 9 introduces data blocks, which better facilitates generalized (i.e. reusable) mechanisms for achieving uniform parallelism as follows.

A property graph (not shown) may contain kinds, such as 902, of vertices such as 921-924. Kind 902 may contain billions of vertices, and uniprocessor bandwidth may cause excessive latency. Vertex table 908 may contain the vertices of kind 902. In some cases, vertex table 908 may be conceptually partitioned into data portions 911-912.

In an embodiment, vertex table 908 is partitioned into portions of a same fixed size. In an embodiment, the fixed size is a count of vertices. In an embodiment, the fixed size is instead a count of bytes, such as a count of multi-byte pages, such as disk blocks or (e.g. virtual) memory segments.

In an embodiment, vertex table 908 is instead partitioned into a fixed count of partitions. In an embodiment, the partition count is the same as, or a multiple of, how many processors are available. In an embodiment, each processor is a networked computer. In an embodiment, each processor is an execution core of a same or different central processing unit (CPU).

Each portion may contain identifiers of vertices, edges, and/or paths. For example, portion 911 contains local identifiers 931-932 of vertices 921-922. Partial result 971 may regard all or much of vertex table 908, which is partitioned into portions 911-912. Each portion, such as 911, may be referenced by a respective data block, such as 961. For example, data block 961 may contain vertex local identifiers 931-932.

A data block may be executed as a unit of work. For example, a data block may be associated with (e.g. contain) metadata that contains signatures as discussed above, such as 981-982, and/or metadata that describes work (e.g. logic) to apply to the data block. For example, a data block may contain vertex or edge identifiers and filter criteria to apply to generate a contribution such as a new data block for inclusion in a new partial result. The new partial result may accumulate one or more new data blocks, such as each from processing a separate old data block, such as each of multiple old data blocks executed on a separate CPU core that may or may not share memory.

Query execution may generate data blocks faster than they can be executed. Data block creation may be decoupled from data block execution by buffering a backlog of pending data blocks within queue 950, which may be a first in first out (FIFO) queue, a priority queue, or an unordered heap. In a synchronous embodiment, such as bulk synchronous parallel (BSP) such as Google MapReduce, Apache Hadoop, or Apache Hama each processor receives a more or less similar data block, such as from sibling data partitions, to process at a same time, with a shared synchronization barrier to await completion by all processors.

In an asynchronous embodiment, such as with Apache Mahout or Apache Spark, each processor may asynchronously dequeue a data block, execute the block, and then dequeue a subsequent data block, with little or no synchronization between multiple processors. In an embodiment, work stealing of already dequeued but as yet unprocessed data blocks may occur between processors. Asynchrony may facilitate further concurrency, such as pipelining or other interleaving of somewhat independent partial results. For example, data block 963 of partial result 972 may be enqueued in between data blocks 961-962 of partial result 971, and in some cases even when partial results 971-972 are for a same query execution.

Data partitioning discussed above entails homogeneous portions 911-912 of same vertex table 908. Whereas in previous FIG. 8, each of partial results 811-813 are heterogeneous. A heterogeneous partial result contains multiple signatures and rows. For example, one row of data block 964 may contain signature 981 and identifier paths 941, and one data block 964 may contain both signatures 981-982, or signatures 981-982 may be contained within separate data blocks (not shown).

Within partial result 812, each row regards one vertex table (i.e. vertex type), which is either cat or dog, depending on which vertex table is specified at the end (i.e. right side) of the signature. Thus, the first and third rows represent cats, and the second and fourth rows represent dogs. In an embodiment, cat rows are stored in one data block, and dog rows are stored in another data block. Aggregation such as with a GROUP BY clause may be accelerated by recognizing which signatures/rows represent which types of vertices or edges and/or by recognizing other aspects of the provenance of each signature/row, such as already applied filtration criteria.

When in separate data blocks, signatures may have different amounts of matching paths, such as with partial result 812 that has more paths to cats than to dogs, and may execute at different speeds. As chains of partial results accumulate and cascade at different speeds, concurrently executing data blocks may represent differing amounts of progress into the sequence of variables in a MATCH clause, and thus the signatures of concurrently executing data blocks may have different lengths.

Division of work discuss above entails either homogenous or heterogeneous data partitioning, which can be used together. For example, dog rows may be stored in a first data block, half of cat rows may be stored in a second data block, and the other half of cat rows may be stored in a third data block. Another way to divide work is functional decomposition, which can be used with or without data partitioning and occurs as follows.

Terms within a query, such as disjunction, may accommodate parallelism. For example, a query may seek pets with a particular wingspan OR pets that are chased, with both sides of the OR clause implemented as separate (e.g. chains of) partial results that may be concurrently executed. Furthermore, activities that are mentioned only once in a query, such as sorting with an ORDER BY clause, may be separately applied to each of parallel execution chains. Thus when separate execution chains are eventually merged, sorting effort is reduced or eliminated. For example, merging two sorted lists into a combined sorted list is easier than merging two unsorted lists into a combined sorted list. Likewise, a same GROUP BY clause may be separately applied to each of parallel execution chains. Generally, such query planning and execution may occur as follows.

Query planning may entail parsing, which may arrange the activities of execution of a query into a tree (not shown) of operators (not shown) that, for example, may or may not correspond to clauses of the query and/or terms of a clause. Query execution may entail executing the operators of the tree in a tree traversal ordering such as post order (i.e. bottom up, leaves before root). The query tree may execute as a data flow graph, with (e.g. intermediate) data gradually becoming available (e.g. derived) and flowing upward from the leaves toward the root (i.e. top).

Sibling nodes (i.e. operators) at a same level in the tree may concurrently execute, finish at different times, and thus data may flow up the tree at different speeds for different parts of the tree. Thus, some operators at different tree levels may concurrently execute. That asynchrony and concurrency of tree execution is facilitated by each tree operator having its own partial result and/or data block(s).

### 10.0 Example Execution Engine Process

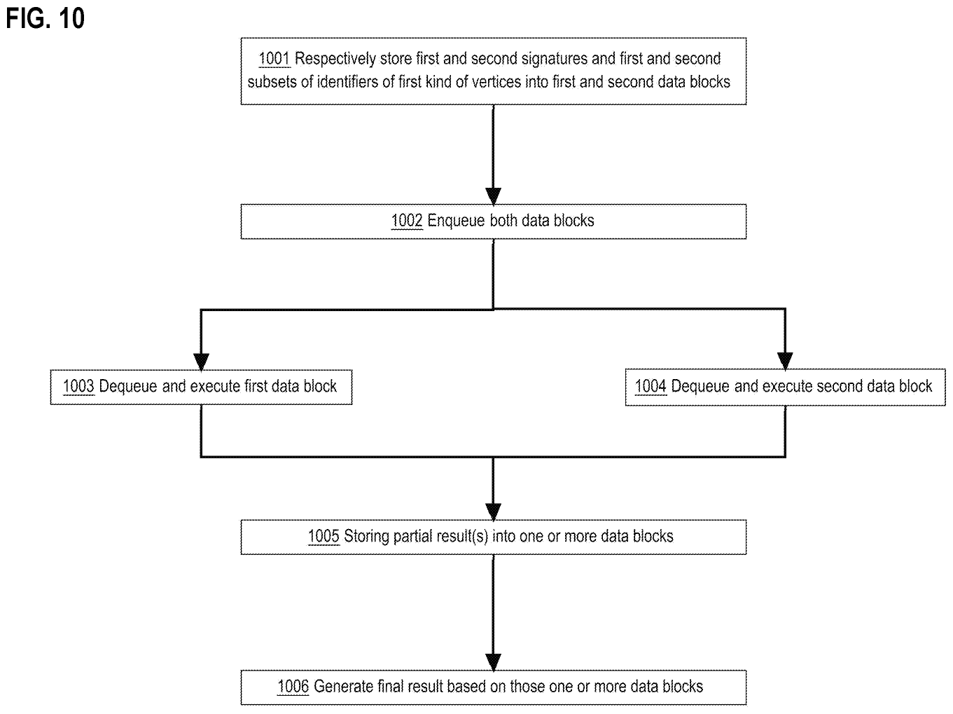

FIG. 10 is a flow diagram that depicts computer 900 as it composes query execution into units of work, some of which may concurrently execute for horizontally scaled acceleration, in an embodiment. FIG. 10 is discussed with reference to FIG. 9.

Edge traversal may be temporally split into at least two phases, each of which consumes an input partial result and generates an output partial result. The first phase selects edges. The second phase selects neighbor (i.e. terminating) vertices. Cascaded edge traversals achieve filtered graph traversal such as for a path query.

The edge selection phase may be further split into an edge identification phase and an edge filtration phase. The edge identification phase randomly accesses edge table(s) to recognize fan out from originating vertex(s). The edge filtration phase accesses edge property vector(s) to apply query filter criteria. If edge properties are not shredded, but instead reside as columns within the edge table, then the edge selection phase is not split into an edge identification phase and an edge filtration phase, but instead executes as a single phase.

The edge filtration phase may be further split into phases as follows. Compound edge criteria that filter multiple properties for a same edge table that is shredded into separate edge property vectors may have a separate filtration phase for each involved edge property vector. Similar phasing may also occur for shredded properties when processing vertices instead of edges. If currently originating vertices are traversed along heterogeneous edges, then each involved edge table has its own sequence of phases that executes separately.

No matter the amount and nature of phases, data partitioning may be applied at any phase for concurrency, with results either recombined or kept separate for subsequent phases. In an embodiment, partitioning and/or recombination of partitions occurs as its own distinct phase. Generally, phases should execute sequentially for a particular partition, although sibling partitions may proceed through the phases asynchronously to each other. In a heavily engineered Hadoop embodiment, each phase and/or each data partition has its own MapReduce job.

Because both phases consume and produce partial results, FIG. 10 depicts a generalized execution engine that may be reused for each phase of traversal, for cascaded traversals, and for other graph data transformation actions such as projection, grouping, sorting, or query tree operator execution.

The flow of FIG. 10 may be repeatedly invoked during query execution to generate a subsequent partial result from a previous partial result, thereby facilitating chained execution within a data processing pipeline. FIG. 10 depicts horizontal scaling for increased bandwidth and (e.g. asynchronous) unit of work queuing and dispatching for increased throughput such as pipelining. An increase in either of bandwidth or throughput alone is sufficient to achieve acceleration (i.e. reduced total latency).

Step 1001 performs homogeneous or heterogeneous data partitioning, which entails storing paths as sequences of identifiers of vertices and edges, along with their signatures, into data blocks according to partitioning scheme(s) as discussed above, such as homogeneously by identifier range or heterogeneously by signature and/or vertex or edge table. Input data, such as edge and/or vertex identifiers, may have come from processing of previous data block(s) and/or partial result(s) such as according to techniques discussed above.

Step 1002 enqueues both data blocks 961-962 onto backlog queue 950 such as by appending or by insertion by priority. Steps 1003-1004 respectively dequeue and execute either of both data blocks, perhaps asynchronously and/or perhaps concurrently according to the implementation and/or scenario. For example, data block 961 may specify originating vertices (e.g. along with paths leading to them), and step 1003 may process data block 961 by identifying a subset of edges of an edge table that originate from those originating vertices.

In some cases, step 1005 waits at a synchronization barrier until both of steps 1003-1004 complete, such as to merge data block(s) emitted by steps 1003-1004. In other cases, there is no merging and/or synchronization. In either case, data blocks that survive or arise from step 1005 are available for subsequent consumption, such as by step 1006 that may, for example, generate a final result, or a partial result, or not occur.

Chained processing is achieved when step 1005 of a previous unit of work (e.g. of a previous phase) also actually is step 1001 of a next unit of work (e.g. of a next phase), meaning that each unit of work may generate next unit(s) of work initialized with current results for subsequent processing. Thus, FIG. 10 generally depicts a data flow engine. Data flow may occur according to a data flow graph, which is not the graph being queried, but instead may be part of a query plan.

Cascaded execution for mechanisms such as phased processing and/or query operator tree processing, as discussed above, may naturally have dependencies between units of work that impose synchronization constraints. Such dependency constraints may restrict when particular units of queued work may be dispatched or should instead be kept pending because input partial results and/or data blocks are not yet available. Thus, backlog queue 950 may be finely managed by a scheduler that enforces dependencies that may or may not be arranged as a data flow graph.

### 11.0 Example Execution Engine Process

The following example pseudocode logics demonstrate an example implementation of the above techniques.

The following is an example query of an example directed property graph, which finds which postal zip code Ann works at.

SELECT place.zip MATCH (person).(visits).(place) WHERE
person.name = ‘Ann’ AND visits.label = ‘workplace’

The following example script implements an example query plan for the above query, which may be automatically generated from the query.

partialSolutions1 = rootNodeMatch(vertices, ‘Ann’)
// When running on the example graph illustrated above,
partialSolutions1 would be: { [People], [ [0] ] },
// since the ID of the vertex with Name ‘Ann’ is 0 and it comes
from the People table
partialSolutions2 = neighborMatch(partialSolutions1,
‘workplace’)
// When running on the example graph (not shown),
partialSolutions2 would be:
// { [People, PeopleToPlaces, Places], [ [0, 0, 0] ] ],
// referring to vertex 0 (‘Ann’) from People, edge 0
(‘workplace’) from PeopleToPlaces, and vertex 0 (‘office’) from
Places
List result = projection(partialSolutions2, ‘ZIP’)
// When running on the example graph (not shown), result would
be: [ 8001 ]

The above query plan script is based on subroutines that implement query tree operators as follows. The subroutines may be automatically generated from the query. The following subroutine finds matching starting vertices for the path query.

operator rootNodeMatch(vertices, name) {

partialSolutions = [:]
for (vt : vertexTables) {

nameProperty = vt.getProperty(‘Name’)
if (nameProperty == null) {

// Skip scanning tables that don't have a property ‘Name’,

since nothing will ever match there

continue

}
// create a solution block in which vertices come from the

vertex table

List partialSolutionsForVt = [ ]
for (personId : vt.vertices) {

if (nameProperty[vertexId] == name) {

partialSolutionsForVt.add([personId])

}
partialSolutions.put([vt], partialSolutionsForVt)

}
return partialSolutions
}

The following subroutine traverses fan out, which entails edge filtration and signature generation.

operator neighborMatch(partialSolutions, label) {

newPartialSolutions = [:]
for ((signature, blocks) : partialSolutions) {

annTable = signature.last( )
// Look in all edge tables that have edges starting from

annTable

for (edgeTable : annTable.getEdgeTablesWhereSource( )) {

labelProperty = edgeTable.getProperty(‘Label’)
if (labelProperty == null) {

// Skip scanning tables that don't have a property

‘Label’, since nothing will ever match there

continue

}

// For labels, we keep an index of the label values in

the table, including how many entities have each label

labelValues = labelProperty.getPropertyValues(label)
if (labelValues.has(label) == false) {

// Nothing will match in this table, skip scanning
continue

}
List partialSolutionsForEt = [ ]
nameProperty = edgeTable.getProperty(‘label’)
if (labelValues.has(label) && labelValues.count(label) ==

edgeTable.size( )) {

// If all edges have the label we are looking for, we

know they match without further checks

for (block : blocks) {

annId = block.last( )
// Retrieve the outgoing edge IDs, using the “begin”

array of the CSR index of this edge table

for (edgeId : edgeTablegetOutgoingEdgeIds(annId)) {

// Retrieve the destination vertex ID using the

“destination” array of the CSR index of this edge table

newPartialSolutions.add([annId, edgeId,

getEdgeDestination(edgeId))

}

}

} else {

// Some edges may match, we have to check each of them
for (block : blocks) {

annId = block.last( )
// Retrieve the outgoing edge IDs, using the “begin”

array of the CSR index of this edge table

for (edgeId : edgeTablegetOutgoingEdgeIds(annId)) {

newPartialSolutions.add([annId, edgeId,

getEdgeDestination(edgeId))

if (labelProperty[edgeId] == label) {

newPartialSolutions.add([annId, edgeId,

getEdgeDestination(edgeId))

}

}

}

}
dstTable = edgeTable.getDestinationTable( )

newPartialSolutions.put([annTable, edgeTable, dstTable],

partialSolutionsForEt)

}

}
return newPartialSolutions

}

The following subroutine projects a property.

operator projection(partialSolutions, propertyName) {

result = [ ]
for ((signature, blocks) : partialSolutions) {

resultTable = signature[2]
property = resultTable.getProperty(propertyName)
for (block : blocks) {

placeId = block[2]
result.add(property[placeId])

}

}
return result

}

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

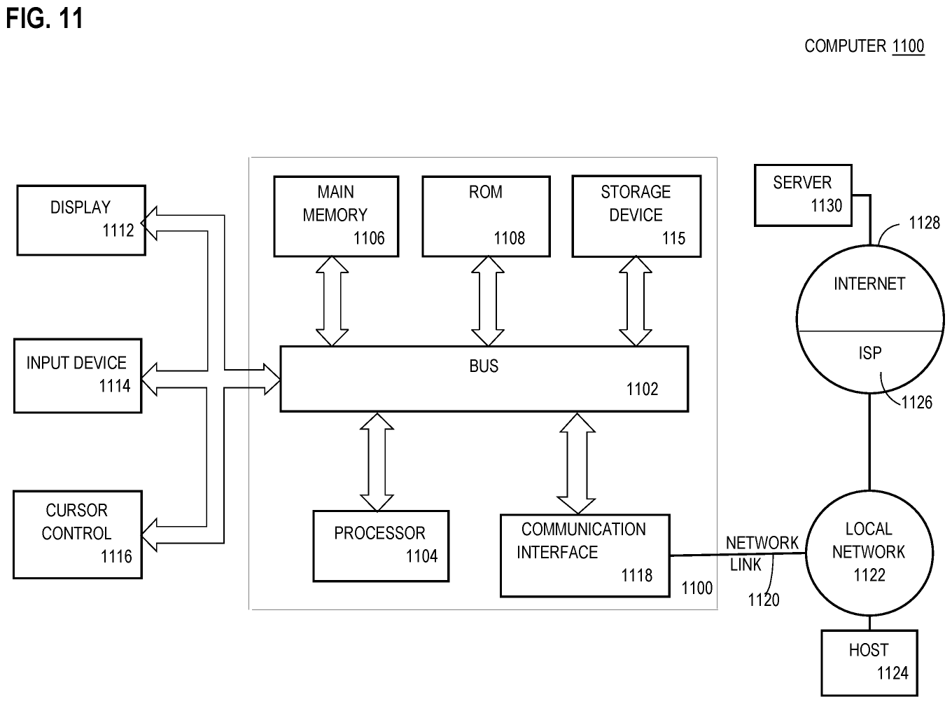

For example, FIG. 11 is a block diagram that illustrates a computer system 1100 upon which an embodiment of the invention may be implemented. Computer system 1100 includes a bus 1102 or other communication mechanism for communicating information, and a hardware processor 1104 coupled with bus 1102 for processing information. Hardware processor 1104 may be, for example, a general purpose microprocessor.

Computer system 1100 also includes a main memory 1106, such as a random access memory (RAM) or other dynamic storage device, coupled to bus 1102 for storing information and instructions to be executed by processor 1104. Main memory 1106 also may be used for storing temporary variables or other intermediate information during execution of instructions to be executed by processor 1104. Such instructions, when stored in non-transitory storage media accessible to processor 1104, render computer system 1100 into a special-purpose machine that is customized to perform the operations specified in the instructions.

Computer system 1100 further includes a read only memory (ROM) 1108 or other static storage device coupled to bus 1102 for storing static information and instructions for processor 1104. A storage device 115, such as a magnetic disk, optical disk, or solid-state drive is provided and coupled to bus 1102 for storing information and instructions.

Computer system 1100 may be coupled via bus 1102 to a display 1112, such as a cathode ray tube (CRT), for displaying information to a computer user. An input device 1114, including alphanumeric and other keys, is coupled to bus 1102 for communicating information and command selections to processor 1104. Another type of user input device is cursor control 1116, such as a mouse, a trackball, or cursor direction keys for communicating direction information and command selections to processor 1104 and for controlling cursor movement on display 1112. This input device typically has two degrees of freedom in two axes, a first axis (e.g., x) and a second axis (e.g., y), that allows the device to specify positions in a plane.

Computer system 1100 may implement the techniques described herein using customized hard-wired logic, one or more ASICs or FPGAs, firmware and/or program logic which in combination with the computer system causes or programs computer system 1100 to be a special-purpose machine. According to one embodiment, the techniques herein are performed by computer system 1100 in response to processor 1104 executing one or more sequences of one or more instructions contained in main memory 1106. Such instructions may be read into main memory 1106 from another storage medium, such as storage device 115. Execution of the sequences of instructions contained in main memory 1106 causes processor 1104 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 115. Volatile media includes dynamic memory, such as main memory 1106. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 1102. Transmission media can also take the form of acoustic or light waves, such as those generated during radio-wave and infra-red data communications.

Various forms of media may be involved in carrying one or more sequences of one or more instructions to processor 1104 for execution. For example, the instructions may initially be carried on a magnetic disk or solid-state drive of a remote computer. The remote computer can load the instructions into its dynamic memory and send the instructions over a telephone line using a modem. A modem local to computer system 1100 can receive the data on the telephone line and use an infra-red transmitter to convert the data to an infra-red signal. An infra-red detector can receive the data carried in the infra-red signal and appropriate circuitry can place the data on bus 1102. Bus 1102 carries the data to main memory 1106, from which processor 1104 retrieves and executes the instructions. The instructions received by main memory 1106 may optionally be stored on storage device 115 either before or after execution by processor 1104.

Computer system 1100 also includes a communication interface 1118 coupled to bus 1102. Communication interface 1118 provides a two-way data communication coupling to a network link 1120 that is connected to a local network 1122. For example, communication interface 1118 may be an integrated services digital network (ISDN) card, cable modem, satellite modem, or a modem to provide a data communication connection to a corresponding type of telephone line. As another example, communication interface 1118 may be a local area network (LAN) card to provide a data communication connection to a compatible LAN. Wireless links may also be implemented. In any such implementation, communication interface 1118 sends and receives electrical, electromagnetic or optical signals that carry digital data streams representing various types of information.

Network link 1120 typically provides data communication through one or more networks to other data devices. For example, network link 1120 may provide a connection through local network 1122 to a host computer 1124 or to data equipment operated by an Internet Service Provider (ISP) 1126. ISP 1126 in turn provides data communication services through the world wide packet data communication network now commonly referred to as the “Internet” 1128. Local network 1122 and Internet 1128 both use electrical, electromagnetic or optical signals that carry digital data streams. The signals through the various networks and the signals on network link 1120 and through communication interface 1118, which carry the digital data to and from computer system 1100, are example forms of transmission media.

Computer system 1100 can send messages and receive data, including program code, through the network(s), network link 1120 and communication interface 1118. In the Internet example, a server 1130 might transmit a requested code for an application program through Internet 1128, ISP 1126, local network 1122 and communication interface 1118.

The received code may be executed by processor 1104 as it is received, and/or stored in storage device 115, or other non-volatile storage for later execution.

### Software Overview

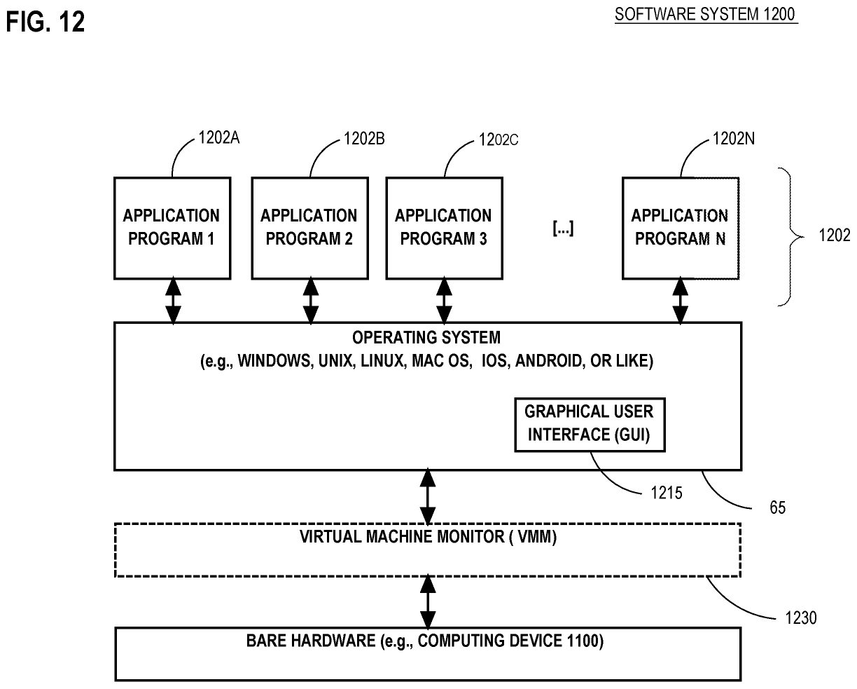

FIG. 12 is a block diagram of a basic software system 1200 that may be employed for controlling the operation of computing system 1100. Software system 1200 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 1200 is provided for directing the operation of computing system 1100. Software system 1200, which may be stored in system memory (RAM) 1106 and on fixed storage (e.g., hard disk or flash memory) 115, includes a kernel or operating system (OS) 65.

The OS 65 manages low-level aspects of computer operation, including managing execution of processes, memory allocation, file input and output (I/O), and device I/O. One or more application programs, represented as 1202A, 1202B, 1202C . . . 1202N, may be “loaded” (e.g., transferred from fixed storage 115 into memory 1106) for execution by the system 1200. The applications or other software intended for use on computer system 1100 may also be stored as a set of downloadable computer-executable instructions, for example, for downloading and installation from an Internet location (e.g., a Web server, an app store, or other online service).

Software system 1200 includes a graphical user interface (GUI) 1215, for receiving user commands and data in a graphical (e.g., “point-and-click” or “touch gesture”) fashion. These inputs, in turn, may be acted upon by the system 1200 in accordance with instructions from operating system 65 and/or application(s) 1202. The GUI 1215 also serves to display the results of operation from the OS 65 and application(s) 1202, whereupon the user may supply additional inputs or terminate the session (e.g., log off).

OS 65 can execute directly on the bare hardware 1220 (e.g., processor(s) 1104) of computer system 1100. Alternatively, a hypervisor or virtual machine monitor (VMM) 1230 may be interposed between the bare hardware 1220 and the OS 65. In this configuration, VMM 1230 acts as a software “cushion” or virtualization layer between the OS 65 and the bare hardware 1220 of the computer system 1100.

VMM 1230 instantiates and runs one or more virtual machine instances (“guest machines”). Each guest machine comprises a “guest” operating system, such as OS 65, and one or more applications, such as application(s) 1202, designed to execute on the guest operating system. The VMM 1230 presents the guest operating systems with a virtual operating platform and manages the execution of the guest operating systems.

In some instances, the VMM 1230 may allow a guest operating system to run as if it is running on the bare hardware 1220 of computer system 1200 directly. In these instances, the same version of the guest operating system configured to execute on the bare hardware 1220 directly may also execute on VMM 1230 without modification or reconfiguration. In other words, VMM 1230 may provide full hardware and CPU virtualization to a guest operating system in some instances.

In other instances, a guest operating system may be specially designed or configured to execute on VMM 1230 for efficiency. In these instances, the guest operating system is “aware” that it executes on a virtual machine monitor. In other words, VMM 1230 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprise two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure and applications.

The above-described basic computer hardware and software and cloud computing environment presented for purpose of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
storing:
a first kind of vertices of a property graph in a first vertex table, and
a second kind of vertices of the property graph in a second vertex table;
generating, without scanning the second vertex table:
an initial partial result of a query of the property graph based on the first vertex table, and
a subsequent partial result of the query based on the initial partial result and the second kind of vertices.

2. The method of claim 1 further comprising:
storing only a subset of directed edges of the property graph in a particular edge table, wherein all edges of the subset of directed edges originate at the first kind of vertices and terminate at the second kind of vertices;
generating an additional partial result of the query based on the initial partial result and the particular edge table by scanning only the subset of directed edges;
wherein the subsequent partial result is based on the additional partial result.

3. The method of claim 2 wherein the particular edge table is stored in compressed sparse row (CSR) format.

4. The method of claim 1 wherein the property graph resides in volatile memory.

5. The method of claim 1 wherein:
the first kind of vertices comprises a particular property;
a vector stores only values of the particular property in a same vertex ordering as the first vertex table;
said generating comprises reading the vector.

6. The method of claim 1 wherein:
the first kind of vertices comprises a particular property;
metadata associates: the particular property with the first kind of vertices, and the first kind of vertices with the first vertex table;
said generating comprises reading the metadata.

7. The method of claim 1 wherein:
the first kind of vertices comprises a particular property;
said generating without scanning the second vertex table comprises detecting that the second kind of vertices does not contain the particular property.

8. The method of claim 1 wherein the initial partial result consists essentially of a set of identifiers of the first kind of vertices.

9. The method of claim 8 wherein said identifiers are offsets into the first vertex table.

10. The method of claim 8 wherein said identifiers do not comprise an identifier of: the first kind of vertices, or the first vertex table.

11. The method of claim 1 wherein generating the initial partial result comprises concurrently:
scanning a first portion of the first vertex table, and
scanning a second portion of the first vertex table.

12. The method of claim 1 wherein generating the initial partial result comprises storing a subset of identifiers of the first kind of vertices into a data block for subsequent processing.

13. The method of claim 12 wherein subsequent processing comprises dequeuing the data block.

14. The method of claim 12 wherein:
the data block comprises a signature that contains a sequence of identifiers of vertex tables and/or edge tables that were accessed to generate the data block;
the method further comprises reading said signature to generate an additional partial result.

15. The method of claim 1 wherein:
the method further comprises storing the initial partial result into one or more data blocks;
the subsequent partial result is based on the one or more data blocks.

16. The method of claim 1 further comprising partitioning a heterogeneous partial result into a plurality of homogeneous data blocks.

17. The method of claim 1 wherein edge traversal comprises separately schedulable phases that include an edge selection phase and a neighbor selection phase.

18. The method of claim 17 wherein the edge selection phase comprises separately schedulable phases that include an edge identification phase and an edge filtration phase.

19. The method of claim 18 wherein the edge selection phase comprises a plurality of separately schedulable edge filtration phases that each accesses a distinct edge property vector.

20. One or more non-transitory computer-readable media storing instruction that, when executed by one or more processors, cause:
storing:
a first kind of vertices of a property graph in a first vertex table, and
a second kind of vertices of the property graph in a second vertex table;
generating, without scanning the second vertex table:
an initial partial result of a query of the property graph based on the first vertex table, and
a subsequent partial result of the query based on the initial partial result and the second kind of vertices.
